(19) United States
(12) Patent Application Publication
(10) Pub. No.: US 2008/0117204 A1
(43) Pub. Date: May 22, 2008

(54) Rendering performance regulator

(76) Inventor: Matthias Thorn, Mohrendorf (DE)

Correspondence Address: BRINKS HOFER GILSON & LIONE, P.O. BOX 10395, CHICAGO, IL, 60610, US

(21) Appl. No.: 11/603,638

(22) Filed: Nov. 22, 2006

(51) Int. Cl. G06T 15/00

(52) U.S. Cl. 345/419

(57) ABSTRACT

A rendering performance regulator is used to assist in rendering and displaying a three-dimensional image of a three-dimensional image dataset on a display device. The rendering performance regulator may be coupled to a processor, a graphics processing unit, or combinations thereof. The three-dimensional image may be static or dynamic. An interface for interacting with the rendering performance regulator is displayed on the display device. The interface allows for changing the quality of the static three-dimensional image and the dynamic three-dimensional image.

### BACKGROUND

1. Technical Field

The present embodiments relate to regulating the performance of rendering three-dimensional images representative of a three-dimensional object stored as a three-dimensional image dataset. In particular, an interface is displayed allowing a user to adjust a static and dynamic rendering of the three-dimensional image dataset in real-time.

2. Related Art

Three-dimensional image datasets are often rendered as static three-dimensional images or dynamic three-dimensional images. Static three-dimensional images permit little to no interactivity with a user, whereas dynamic three-dimensional images permit increased interactivity with a user. More often, users prefer increased interactivity with rendered and displayed three-dimensional images. However, manipulation of statically rendered three-dimensional images often require users to wait until the three-dimensional image is completely rendered. In these cases, the user would like to be able to reduce the static rendering quality quickly and simply. Similarly, where the user is manipulating a dynamically rendered three-dimensional image, a user must often wait until the dynamic scene is completely rendered. However, a user is often willing to sacrifice quality of the dynamically rendered three-dimensional image for increased interactivity.

Current systems today are limited to confusing configuration menus, in which the user navigates a plethora of cascading menus before being able to adjust the quality of the dynamic and static rendering. Thus, with today's systems, users cannot easily or intuitively change the quality of static or dynamic renderings of three-dimensional image datasets.

### SUMMARY

By way of introduction, the embodiments described below include a system and a method for regulating the rendering of three-dimensional images displayed on a display device. The system includes a memory storage device, a processor, and a display device. The memory storage devices stores a three-dimensional image dataset representative of a three-dimensional object. The processor receives the three-dimensional image dataset from the memory storage device and renders the three-dimensional image dataset as the three-dimensional image on the display device. The display device displays the three-dimensional image rendered by the processor and an interface that can be used to regulate the performance of the processor in rendering the three-dimensional image.

In one embodiment, the interface includes a progress indicator, a processor bar, and at least one input handler. The progress indicator indicates the rendering quality of the three-dimensional image, and the process bar indicates the progress of rendering the three-dimensional image by the processor. The at least one input handler is used to select the rendering quality of the three-dimensional image.

The method includes storing a three-dimensional image dataset representative of a three-dimensional object on a memory storage device and receiving the three-dimensional image dataset from the memory storage device. The method also includes rendering the three-dimensional image dataset as the three-dimensional image, and displaying the rendered three-dimensional image along with the interface that regulates the rendering of the three-dimensional image.

The present invention is defined by the following claims, and nothing in this section should be taken as a limitation on those claims. Further aspects and advantages of the embodiments are discussed below in conjunction with the preferred embodiments and may be later claimed independently or in combination.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of one embodiment of a system for regulating the rendering of three-dimensional image datasets.

FIG. 2 is a schematic diagram illustrating an interface for regulating the rendering of three-dimensional images displayed on a display device.

FIG. 3 is a schematic diagram illustrating another interface for regulating the rendering of three-dimensional images displayed on a display device

FIG. 4 is an image showing the interface for regulating the rendering of three-dimensional images overlaid on a rendered three-dimensional image.

FIG. 5 is a flow chart diagram of one embodiment of a method for regulating the rendering of three-dimensional images displayed on a display device.

### DETAILED DESCRIPTION

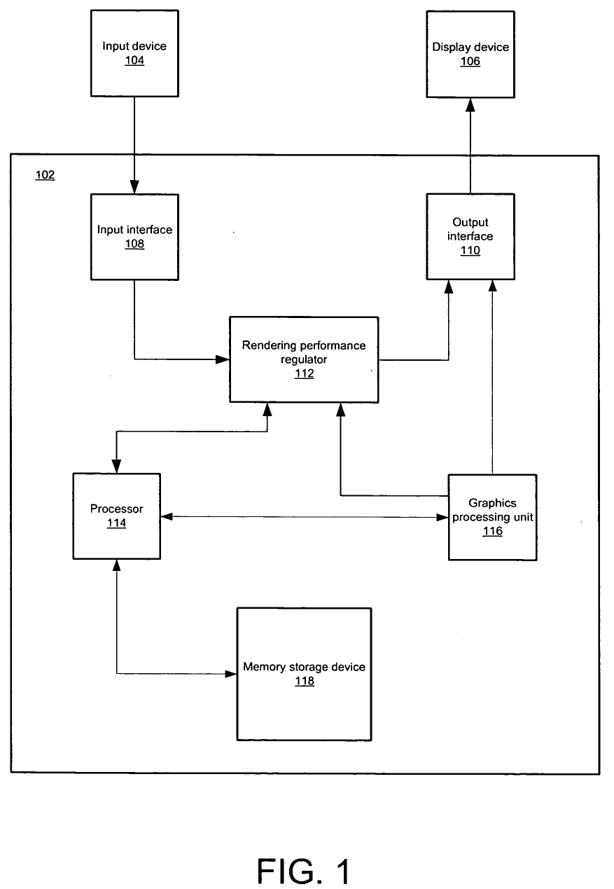

FIG. 1 shows one embodiment of a system 102 for regulating the rendering of three-dimensional images displayed on a display device 106. The system 102 includes an input interface 108 coupled with an input device 104 and a rendering performance regulator 112. The system 102 further includes an output interface 110 coupled with a display device 106, and a graphics processing unit 116. A memory storage device 118 also resides in the system 102 and is coupled with the processor 114. The processor 114 is coupled with the graphics processing unit 116 and the rendering performance regulator 112. The rendering performance regulator 112 is also coupled with the graphics processing unit 116. Herein, the phrase “coupled with” is defined to mean directly connected to or indirectly connected through one or more intermediate components. Such intermediate components may include both hardware and software based components.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The memory storage device 118 is operative to store a three-dimensional image dataset representative of a three-dimensional object. The memory storage device 120 may be random access memory, cache memory, dynamic random access memory, static random access memory, flash memory, virtual memory, video memory, magnetic memory, optical memory, any known or later developed memory technology, or combinations thereof. In one embodiment, the memory storage device 118 is a hard drive. In another embodiment, the memory storage device 118 is a DVD+RW. In a further embodiment, the memory storage device 118 is a secure digital (SD) card, or other now known or later developed data storage device. The memory storage device 118 may be further operative to communicate with the processor 114, such that the processor 114 is operative to receive the three-dimensional image dataset from the memory storage device 118.

The processor 114 is a general processor, a data signal processor, graphics card, graphics chip, personal computer, motherboard, memories, buffers, scan converters, filters, interpolators, field programmable gate array, application-specific integrated circuit, analog circuits, digital circuits, combinations thereof, or any other now known or later developed processing or rendering device. The processor 114 may also be a software module written in a computer programming language, including, but not limited to, BASIC, C, Dylan, Euphoria, ASP, C++, Java, Python, PHP, Javascript, or combinations thereof. The processor 114 communicates with the memory storage device 118 to receive the three-dimensional image dataset from the memory storage device 118. The processor 114 further includes software or hardware for rendering a three-dimensional image representative of the three-dimensional object stored as the three-dimensional image dataset.

Rendering includes the creation of a two-dimensional image containing geometric models, using color and/or shading to produce a realistic or photo-realistic three-dimensional image. Rendering generally uses mathematics to describe the location of a light source in relation to the object and to calculate the way in which the light would create highlights, shading, and variations in color. The degree of realism can range from opaque, shaded polygons to images approximating photographs in their complexity. Rendering techniques include, but are not limited to, alpha blending, minimum intensity projection, maximum intensity production, surface rendering, ray casting, ray tracing, or other now known or later developed rendering technique, or combinations thereof. In one embodiment of the system 102 for regulating the rendering of three-dimensional images displayed on a display device, the processor 114 renders the three-dimensional image dataset received from the memory storage device 118 on the display device 106 via output interface 110.

In one embodiment, the three-dimensional image dataset is a dataset of medical data representative of an organ cavity or portion of a patient. In another embodiment, the three-dimensional image dataset is a dataset of medical data representative of an organ cavity or portion of a patient that includes a temporal indicator. For example, the three-dimensional image dataset may be a dataset of medical data representative of a heart, or a dataset of medical data representative of a heart that changes in volume over a predetermined amount of time. As another example, the three-dimensional image dataset may be a dataset of medical data representative of a patient's lungs, or a dataset of medical data representative of the patient's lungs as they change in volume over a predetermined amount of time. Other organs or portions of a patient are also contemplated.

The three-dimensional image dataset may be acquired using any three dimensional technique, including pre-operative techniques, intra-operative techniques, fused 3-D volume imaging techniques, any other now known or later developed techniques, or combinations thereof. Examples of pre-operative techniques include, but are not limited to, computed tomography (CT), magnetic resonance imaging (MRI), positron emission tomography (PET), single photon emission computed tomography (SPECT), ultrasound, or combinations thereof. Examples of intra-operative techniques include, but are not limited to, 3D digital subtraction angiography, 3D digital angiography, rotational angiography, such as the DynaCT technique developed by Siemens Medical Solutions of Siemens AG, 3D ultrasound, or combinations thereof. Examples of fused 3-D volume imaging techniques include, but are not limited to, the PET/CT imaging technique and the SPECT+CT imaging technique, both developed by Siemens Medical Solutions of Siemens AG. Other types of three-dimensional imaging techniques now known or later developed are also contemplated.

The three-dimensional image dataset also includes various features that describe the resulting three-dimensional image. For example, the three-dimensional image dataset may have a polygonal feature that describes the numbers and types of geometric shapes used to render the three-dimensional image dataset. As another example, the three-dimensional image dataset may also have one or more texture features that describe the types and qualities of textures to apply to the surfaces of the polygons used in rendering the three-dimensional image. Other features include, but are not limited to shading, texture-mapping, bump-mapping, fogging/participating medium, shadows, soft shadows, reflection, transparency, translucency, refraction, indirect illumination, caustics, the depth of field, any motion blur, or combinations thereof. The attributes may also include instructions for the processor 114, graphics processing unit 116, or combinations thereof, as to how to render the resulting three-dimensional image, such as by alpha blending, minimum intensity projection, maximum intensity production, surface rendering, ray tracing, ray casting, or combinations thereof.

Alternatively, or in addition to, the rendering performed by the processor 114, the processor 114 may also communicate with the graphics processing unit 116 to render the three-dimensional image from the three-dimensional image dataset. In one embodiment, the graphics processing unit 116 is a processor coupled with the processor 114. In another embodiment, the graphics processing unit 116 is software written in a computer programming language, such as BASIC, C, Dylan, Euphoria, ASP, C++, Java, Python, PHP, Javascript, any now known or later developed computer programming language, or combinations thereof. The graphics processing unit 116 may also be processor 114.

The graphics processing unit 116 is operative to perform computational calculations related to three-dimensional computer graphics. For example, the graphics processing unit 116 may perform operations related to texture mapping, polygon rendering, vertex mapping, or combinations thereof, in one or more coordinate systems. The graphics processing unit 116 may further include programmable shaders operable to manipulate vertices and textures, including oversampling techniques to reduce aliasing, and high-precision color formats. The graphics processing unit 116 may also include hardware and/or software for two-dimensional acceleration and frame buffer capabilities. Examples of commercially available graphics processing units include the Radeon X1950 XTX available from ATI Technologies, Inc., headquartered in Markham, Ontario, Canada; the GeForce 7950 GX2 available from NVIDIA Corp., headquartered in Santa Clara, Calif.; and the Parhelia 256 MB, available from Matrox Electronic Systems, Ltd., headquartered in Dorval, Quebec, Canada.

Depending on the complexity of the three-dimensional dataset, the processor 114 may use the graphics processing unit 116 to off-load some or all of the computational demands for rendering and displaying the three-dimensional image dataset on the display device 106. Alternatively, the processor 114 may by-pass the graphics processing unit 116 to render the three-dimensional image on the display device 106.

In addition to the features previously described, the three-dimensional image dataset may also specify default-quality levels for rendering one or more features by the processor 114, graphics processing unit 116, or combinations thereof. The default-quality levels may be pre-determined prior to storing the three-dimensional image dataset in the memory storage device 118 or may be established while storing the three-dimensional image dataset in the memory storage device 118. A user or system could also set the default-quality levels after storing the three-dimensional image dataset in the memory storage device 118.

The quality of the rendering of the three-dimensional image may be affected by the level of the feature displayed or whether the feature is displayed at all. For example, the three-dimensional image dataset may specify that the default-quality for rendering the number of polygons of the three-dimensional image dataset is 5000. Thus, any rendering that includes more than 5000 polygons, such as 8000 polygons, may be considered a high-quality rendering. Similarly, any rendering that includes less than 5000 polygons, such as 2000 polygons, may be considered a low-quality rendering. As another example, the three-dimensional image dataset may define the features of shading, reflection, bump-mapping, transparency, and texture-mapping, but specify that the default-quality for rendering the three-dimensional image dataset is bump-mapping, transparency, and texture-mapping. Hence, if a rendering does not include each of the specified features for a default-quality rendering, the rendering may be considered a low-quality rendering. However, if a rendering includes more than one of the specified default-quality features, such as a rendering that includes shading in addition to bump-mapping, transparency, and texture-mapping, the rendering may be considered a high-quality rendering. High and low are used as relative terms. A high quality rendering may be considered low quality in other situations.

Accordingly, any rendering of the three-dimensional image dataset that reduces the default-quality level for one or more features may be considered a low-quality rendering of the three-dimensional image dataset. Conversely, any rendering that increases the default-quality level for one or more features may be considered a high-quality rendering of the three-dimensional image dataset. As previously discussed, the default-quality level rendered by the processor 114, the graphics processing unit 116, or combinations thereof, may be pre-set by the three-dimensional image dataset, defined by the hardware constraints of the system 102, defined by the user of the system 102 prior to rendering the three-dimensional image dataset, or combinations thereof. Any of using a feature, altering a parameter of a feature, selecting a type of rendering, or combinations thereof may be used for altering rendering quality.

In another embodiment, the quality of the rendering of the three-dimensional image dataset may be affected by the number of images displayed on the display device 106 during a predetermined amount of time. For example, the quality of the rendering of the three-dimensional image may be measured and/or adjusted by the number of images per second displayed on the display device 106. In this embodiment, the rendering performance regulator 112 determines a threshold level of images displayed per unit of time as to whether the rendered images are higher quality images or lower quality images. For example, the rendering performance regulator 112 may determine that the threshold level of images displayed per unit of time is five images displayed per second. In this example, more than five images displayed per second are considered lower quality images and less than five images displayed per second are considered higher quality images. Images that are displayed as five images displayed per second may be considered, low-quality images, high-quality images, or default-quality images. In another example, the rendering performance regulator 112 may use another number of images displayed per unit of time, other units of time, or combinations thereof, to determine the threshold level of quality.

The rendering of the three-dimensional image is a dynamic rendering or a static rendering. A dynamic rendering is a rendering that allows a user of the system 102 to interact with the three-dimensional image as the processor 114, graphics processing unit 116, or combinations thereof, is rendering the three-dimensional image on the display device 106. The dynamic rendering may be a real-time rendering while the user is interacting with the three-dimensional image. Interacting with the three-dimensional image may include user manipulation of the three-dimensional image while the three-dimensional image is being rendered. As explained in further detail below, the user may use the input device 104 to manipulate the three-dimensional image. Manipulation of the three-dimensional image includes, but is not limited to, the actions of scaling, rotating, skewing, deforming, transforming, resizing, any other now known or later developed manipulation techniques, or combinations thereof.

The quality of the dynamic rendering performed by the processor 114, the graphics processing unit 116, or combinations thereof, may be a low-quality, default-quality, or high-quality rendering. In one embodiment, as a low-quality rendering of the three-dimensional image dataset includes a reduction in the default-quality of one or more features specified by the three-dimensional image dataset, a low-quality rendering of the three-dimensional image dataset is not as computationally tasking on the processor 114, graphics processing unit 116, or combinations thereof. Hence, in this embodiment, a low-quality dynamic rendering of the three-dimensional image dataset permits increased interactivity with the three-dimensional image as the processor 114, graphics processing unit 116, or combinations thereof, can devote more time to the computational efforts of manipulating the three-dimensional image. Alternatively, a low-quality rendering of the three-dimensional image dataset includes an increase in the number of images displayed during a predetermined unit of time, such as seconds. Hence, in this embodiment, an increase in the number of images displayed during the predetermined unit of time, permits increased interactivity with the rendered three-dimensional image. Thus, a user may want to display a low-quality rendering of the three-dimensional image dataset if the user prefers interactivity with the three-dimensional image over the quality of the rendered image.

In addition to a low-quality dynamic rendering, it is also possible that the dynamic rendering of the three-dimensional image dataset is a high-quality dynamic rendering. Although computationally more complex than a low-quality rendering, a high-quality dynamic rendering allows a user to interact with a more photorealistic image or rendering with enhanced features of the three-dimensional image dataset. Depending on the processing power of the processor 114, the graphics processing unit 116, or combinations thereof, the visible difference in manipulating a low-quality dynamic rendering of the three-dimensional image dataset and a high-quality dynamic rendering of the same three-dimensional image dataset may be noticeable or hardly detectable. For example, the visible difference may be noticeable in the frame rate, that is, the number of frames rendered per second, of the rendered dynamic three-dimensional image displayed by the display device 106. In another example, the visible difference may be noticeable in the number of images per second of the rendered dynamic three-dimensional image displayed by the display device 106.

The rendering of the three-dimensional image dataset on the display device 106 may also be a static rendering. A static rendering is a rendering that permits little or no interaction by the user of the system 102 with the rendered three-dimensional image. However, because the static rendering permits little or no interaction, the computational efforts by the processor 114, graphics processing unit 116, or combinations thereof, can be directed to the rendering quality of the three-dimensional image. Thus, the rendering quality of the static rendered three-dimensional image may be a high-quality static rendering. The rendering quality of the static rendered three-dimensional image may also be a higher quality rendering than the rendering quality of the dynamic rendered three-dimensional image. For example, the static rendered three-dimensional image may be a photorealistic three-dimensional image, whereas the dynamic rendered three-dimensional image may be a low-quality three-dimensional image. However, this does not preclude the static rendered three-dimensional image from being a low-quality, lower quality than a dynamic rendering, or default-quality static rendered three-dimensional image. For example, the user of the system 102 may want low-quality static rendered three-dimensional images to view still images of the three-dimensional image dataset quickly and effortlessly.

While rendering the three-dimensional image of the three-dimensional image dataset, the processor 114, graphics processing unit 116, or combinations thereof are in communication with the rendering performance regulator 112. In one embodiment, the rendering performance regulator 112 is a processor. In another embodiment, the rendering performance regulator is software written in a computer programming language, such as BASIC, C, Dylan, Euphoria, ASP, C++, Java, Python, PHP, Javascript, any now known or later developed computer programming language, or combinations thereof. The regulator 112 may be the processor 114.

The rendering performance regulator 112 communicates with the processor 114, graphics processing unit 116, or combinations thereof, to control the performance of the rendering of the three-dimensional image dataset. The rendering performance regulator 112 is operative to send instructions to the processor 114, graphics processing unit 116, or combinations thereof, that instruct the processor 114, graphics processing unit 116, or combinations thereof, as to the quality of the rendered three-dimensional image. The rendering performance regulator 112 is further operative to send instructions regarding the quality of both dynamic and static rendered three-dimensional images. For example, the rendering performance regulator 112 may instruct the processor 114, graphics processing unit 116, or combinations thereof, to render the static rendering of the three-dimensional image dataset as a high-quality three-dimensional image and to render the dynamic rendering of the three-dimensional image dataset as a low-quality three-dimensional image. As another example, the rendering performance regulator 112 may instruct the processor 114, graphics processing unit 116 or combinations thereof, to render the static rendering of the three-dimensional image dataset as a low-quality three-dimensional image and to render the dynamic rendering of the three-dimensional image dataset as a high-quality three-dimensional image. As a further example, the rendering performance regular 112 may instruct the processor 114, graphics processing unit 116, or combinations thereof, to render the static rendering of the three-dimensional image dataset as a default-quality three-dimensional image and to render the dynamic rendering of the three-dimensional image dataset as a default-quality three-dimensional image. Other combinations are also possible, such as rendering only a static image or only a dynamic image.

The rendering performance regular 112 also receives input from the processor 114, the graphics processing unit 116, or combinations thereof. The input received from the processor 114, graphics processing unit 116, or combinations thereof, inform the rendering performance regulator 112 of the process made by the processor 114, graphics processing unit 116, or combinations thereof, in rendering the three-dimensional image dataset on the display device 106. Using the input received from the processor 114, graphics processing unit 116, or combinations thereof, the rendering performance regulator 112 can provide graphical information, textual information, or combinations thereof, to the user via the display device 106 as to the completion of rendering the three-dimensional image dataset on the display device 106. Alternatively, the information is generated or provided by the regulator 112 and input is not received from the processor 114 or graphics processing unit 116.

The output interface 110 facilitates the rendering of the three-dimensional image dataset on display device 106 by the processor 114, graphics processing unit 116, or combinations thereof. The output interface 124 may be a wired interface, such as PS/2, USB, Ethernet, IDE/ATA, SCSI, SATA, IEEE 1394, VGA, or DVI, a wireless interface, such as 802.11a/b/g, Bluetooth, RF, infrared, an audio interface, such as stereo, S/PDIF, AES/EBU, or combinations thereof. The output interface 110 is also coupled to the rendering performance regulator 112 to facilitate the display on the display device 106 of a user interface for interacting with the rendering performance regulator 112.

The display device 106 displays the rendering of the three-dimensional image rendered by the processor 114, the graphics processing unit 116, or combinations thereof, communicated through the output interface 110. The display device 116 is a monitor, CRT, LCD, plasma screen, flat-panel, projector are other now known or later developed display device. As explained below, the display device 106 generates an image representative of the three-dimensional image dataset rendered by the processor 114, the graphics processing unit 116, or combinations thereof. The display device 106 also displays text and/or graphics representative of an interface for the user to interact with the rendering performance regulator 112.

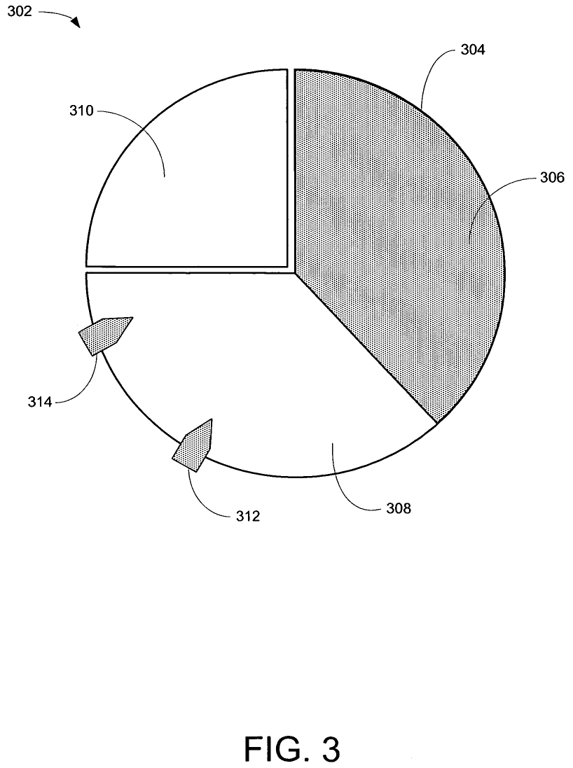

The image of the rendered three-dimensional image dataset and the image of the interface for interacting with the rendering performance regulator 112 may be displayed as one or more images on the display device 106. For example, and shown in FIG. 3 explained below, the image of the interface for the rendering performance regulator 112 may be overlaid on the image of the rendered three-dimensional dataset. As another example, the image of the interface for the rendering performance of regulator 112 may be displayed as a separate image not overlaid on the image of rendered three-dimensional image dataset.

As the display device 106 may be one or more display devices, it is also possible that the image of the rendered three-dimensional image dataset is displayed on a separate display device different from the display device that displays the image of the interface of the rendering performance regulator 112. The user of the system 102 may use the input device 104 to manipulate the image of the rendered three-dimensional dataset and the image of the interface of the rendering performance regulator 112 displayed on the display device 106.

The input interface 108 is coupled with the input device 108 and operative to communicate with the rendering performance regulator 112, the processor 114, and the graphics processing unit 116. The input interface 108 may be a wired interface, such as PS/2, USB, Ethernet, IDE/ATA, SCSI, or SATA, IEEE 1394, a wireless interface, such as 802.11 a/b/g, Bluetooth, RF, infrared, an audio interface, such as stereo, S/PDIF, AES/EBU, or combinations thereof. In one embodiment, the input interface 108 is a PS/2 interface coupled with the input device 104, which is a keyboard. In another embodiment, the input interface 108 is an IDE/ATA interface and the input device 104 is a hard drive.

The input device 104 may be an audio input device, a tactile input device, a memory storage device, any now known or later developed input device, or combinations thereof. In one example, the input device 104 is a microphone. In another example, the input device 104 is a keyboard, mouse, trackball, touch pad or other pointer control. In another example, the input device 104 is a memory storage device, such as a hard disk drive, compact disc, digital video disc, flash memory, random access memory, or combinations thereof. Using the input device 104, the user can interact with the rendering performance regulator 112 via the interface displayed on the display device 106. Through the interface displayed on the display device 106 and using the input device 104, the user can change the quality level of the dynamic rendering of the three-dimensional image dataset and the quality level of the static rendering of the three-dimensional image dataset. The user can also interact with the rendered three-dimensional image displayed on the display device 106, such as through manipulation, using the input device 104. Furthermore, the user may set or adjust the default-quality of the static rendering and the default-quality of the dynamic rendering using the input device 104.

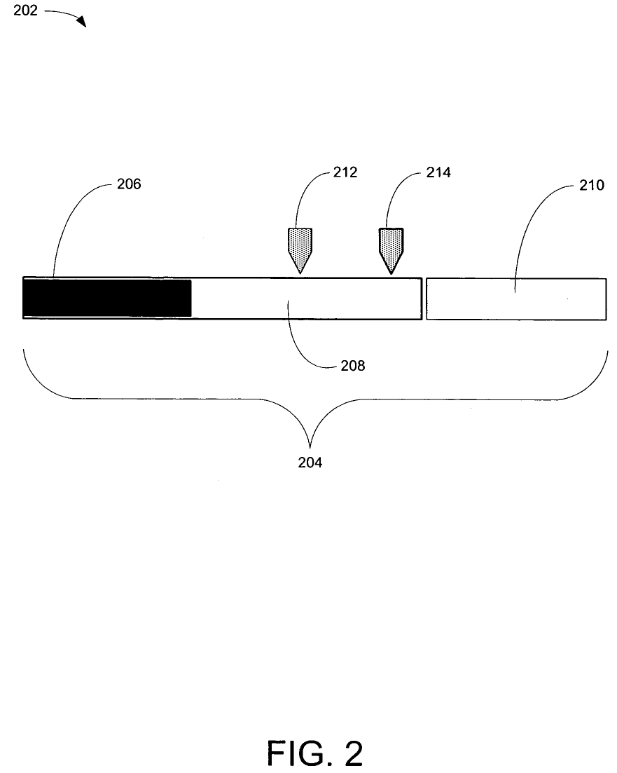

FIG. 2 is a schematic diagram illustrating an interface 202 for regulating the rendering of three-dimensional images displayed on the display device 106. As shown in the embodiment of FIG. 2, the interface 202 comprises a progress indicator 204, a process bar 206, a first input handler 212, and a second input handler 214.

In one embodiment, the progress indicator 204 indicates the rendering quality selected by the user for the three-dimensional image. The progress indicator 204 includes a progress indicator for the dynamic rendering of the three-dimensional image dataset 208, and a progress indicator for the static rendering of the three-dimensional image dataset 210.

The process bar 206 indicates the progress of rendering of three-dimensional dataset on the display device 106. In one embodiment, the progress bar 206 progresses from left to right. In another embodiment, the progress bar 206 progresses from right to left. Other orientations are also possible. Other indicators than bars, such as counts, spirals, hour-glass graphic or pie chart type, may be used. The progress bar 206 progresses along the path defined by the progress indicator 204. When the rendering of the three-dimensional image dataset is a dynamic rendering, the progress bar 206 proceeds along the path defined by the dynamic progress indicator 208. When the rendering of the three-dimensional image data is a static rendering, the progress bar 206 proceeds along the path defined by the static progress indicator 210. The progress bar 206 may or may not proceed from the dynamic progress indicator 208 to the static progress indicator 210, or from the static progress indicator 210 to the dynamic progress indicator 208.

To adjust the quality of the rendered three-dimensional image, static or dynamic, a user uses input handlers 212, 214. In one embodiment, the first input handler 212 is associated with the quality of rendering dynamic images from the three-dimensional image dataset, and the second input handler 214 is associated with the quality of rendering static images from the three-dimensional image dataset.

It is also possible to adjust the quality of one mode of the rendered three-dimensional image without affecting the display of the currently rendered three-dimensional image. As an example, suppose that the currently rendered three-dimensional image is a static rendering of the three-dimensional image and the user desires to adjust the quality of the dynamic rendering of the three-dimensional image. In this example, the user may adjust the quality of the dynamic rendering of the three-dimensional image without having to display a dynamic rendering of the three-dimensional image dataset. Thus, the user may continue viewing the static rendering of the three-dimensional image dataset while adjusting the quality of the dynamic rendering of the three-dimensional image dataset. Similarly, where the currently displayed image is a dynamic rendering of the three-dimensional image dataset, the user may adjust the quality of the static rendering of the three-dimensional image dataset without affecting the display of the dynamic rendering.

Each input handler 212, 214 moves along the path defined by the progress indicator 204. Movement along the path defined by the progress indicator 204 may adjust the quality level of one or more features of the three-dimensional image dataset. For example, the user may define that the movements of the first input handler 212 and the second input handler 214 adjust the quality level of textures appearing in the dynamic and static rendered image. As another example, the user may define that the movements of the first input handler 212 and the second input handler 214 adjust the quality level of polygons appearing in the dynamic and static rendered image. As a further example, the user may define that the movements of the first input handler 212 and the second input handler 214 adjust the quality level of both polygons and textures appearing in the dynamic and static rendered three-dimensional images. Thus, where decreases in quality are associated with the left side of the progress indicator 204 and increases in quality are associated with the right side of the progress indicator 204, moving the first input handler 212 or the second input handler 214 to the left will decrease the quality level of the rendered three-dimensional image. Similarly, moving the first input handler 212 or the second input handler 214 to the right will increase the quality level of the rendered three-dimensional image. In another embodiment, the user may define one or more points along the progress indicator 204, the dynamic progress indicator 208, the static indicator 210, or combinations thereof, as the default-quality level of the rendered three-dimensional image. System defined or predetermined adjustments may be used. The different handlers 212, 214 may handled different features for adjusting quality.

In yet a further embodiment, the first input handler 212 is associated with the time the processor 114, the graphics processing unit 116, or combinations thereof should complete the dynamic rendering of the three-dimensional image dataset, and the second input handler 214 is associated with the time the processor 114, the graphics processing unit 116, or combinations thereof, should complete the static rendering of the three-dimensional image dataset. In this embodiment, adjustments using the first input handler 212 and the second input handler 214 that decrease the time of completion for rendering the dynamic and static three-dimensional images, also decrease the quality of the dynamic and static three-dimensional images. Similarly, adjustments using the first input handler 212 and the second input handler 214 that increase the time of completion for rendering the dynamic and static three-dimensional images, also increase the quality of the dynamic and static three-dimensional images.

In one embodiment, to correspond a time of completion with the quality of the dynamic or static rendered three-dimensional image, the rendering performance regulator 112 may maintain a database of features and the time required by the processor 114, the graphics processing unit 116, or combinations thereof, to render those features. In another embodiment, the rendering performance regulator 112 examines the dimensions of the dynamic or static rendered three-dimensional image to be displayed on the display device 106 and the size of the three-dimensional image dataset stored in the memory storage device 118 to determine the time of completion of rendering the three-dimensional image dataset by the processor 114, the graphics processing unit 116, or combinations thereof.

The time of completion may be an amount of time spent by the processor 114, the graphics processing unit 116, or combinations thereof, in rendering the three-dimensional image dataset, a time at which the rendering of the three-dimensional image dataset is to be completed, or combinations thereof. The time of completion may be measured in seconds, minutes, hours, processor cycles, frames per second, images per second, remaining frames to render, remaining images to render, total number of frames rendered, total number of images rendered, other measurements of time, or combinations thereof.

In an additional embodiment, the first input handler 212 is associated with the dynamic rendering of the three-dimensional image dataset and the number of images the processor 114, the graphics processing unit 116, or combinations thereof should rendered per unit of time, and the second input handler 214 is associated with the static rendering of the three-dimensional image dataset and the number of images the processor 114, the graphics processing unit 116, or combinations thereof, should render per unit of time. In this embodiment, adjustments using the first input handler 212 and the second input handler 214 that increase the number of rendered images displayed per unit of time for the dynamic and static three-dimensional images, also decrease the quality of the dynamic and static three-dimensional images. Similarly, adjustments using the first input handler 212 and the second input handler 214 that decrease the number of rendered images displayed per unit of time for rendering the dynamic and static three-dimensional images, also increase the quality of the dynamic and static three-dimensional images.

FIG. 3 is a schematic diagram illustrating another interface 302 for regulating the rendering of three-dimensional images displayed on the display device 106. As shown in the embodiment of FIG. 3, the interface 302 comprises a progress indicator 304, a process portion 306, a first input handler 310, and a second input handler 312.

In one embodiment, the progress indicator 304 indicates the rendering quality selected by the user for the three-dimensional image. The progress indicator 304 includes a progress indicator for the dynamic rendering of the three-dimensional image dataset 308, and a progress indicator for the static rendering of the three-dimensional image dataset 310. In the embodiment shown in FIG. 3, the process portion 306 indicates the progress of rendering of three-dimensional dataset on the display device 106. In one embodiment, the progress portion 306 progresses in a clockwise direction around the progress indicator 304 to indicate completion of the rendering process. In another embodiment, the progress portion 306 progresses around the progress indicator 304 in a counterclockwise direction to indicate completion of the rendering process.

To adjust the quality of the rendered three-dimensional image, static or dynamic, a user uses input handlers 312, 314. Each input handler 312, 314 moves along the path defined by the progress indicator 304. Movement along the path defined by the progress indicator 304 may adjust the quality level of one or more features of the three-dimensional image dataset. For example, where decreases in quality are associated with counter-clockwise movements along the progress indicator 304 and increases in quality are associated with clockwise movements along the progress indicator 304, moving the first input handler 312 or the second input handler 314 in a counter-clockwise direction will decrease the quality level of the rendered three-dimensional image. Similarly, moving the first input handler 312 or the second input handler 314 in a clockwise direction will increase the quality level of the rendered three-dimensional image. In another embodiment, the user may define one or more points along the progress indicator 304, the dynamic progress indicator 308, the static indicator 310, or combinations thereof, as the default-quality level of the rendered three-dimensional image. System defined or predetermined adjustments may also be used.

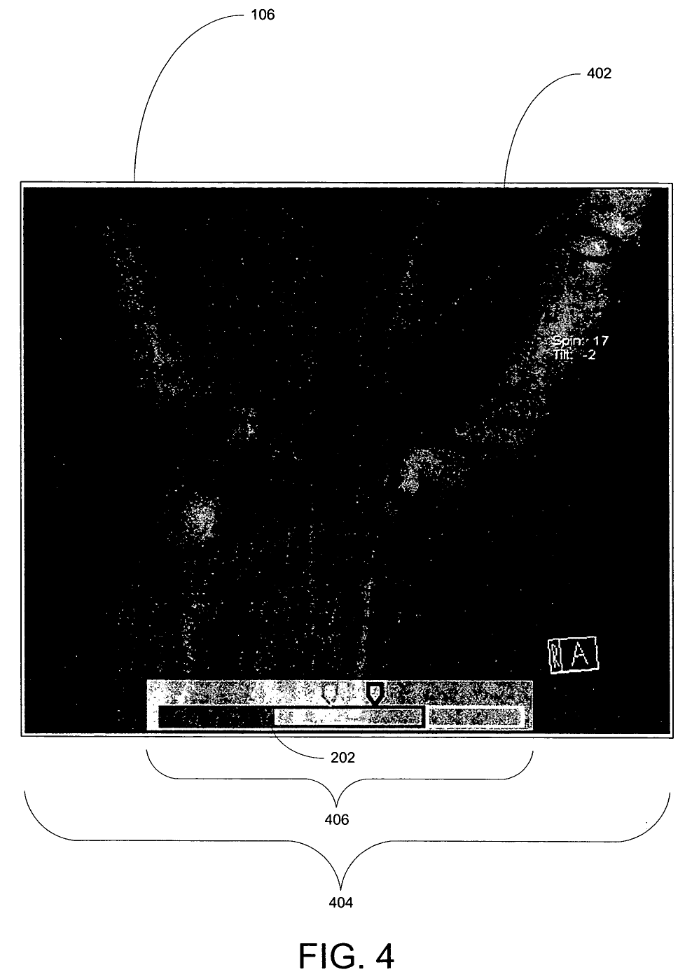

FIG. 4 is an image showing the interface 202 for regulating the rendering of three-dimensional images superimposed on a three-dimensional image 404. In the embodiment shown in FIG. 4, the display device 106 displays an image 402 comprising an interface image portion 406 where the interface 202 is displayed, and a three-dimensional image portion 404 where the three-dimensional image is displayed. Although the interface image portion 406 is displayed overlaid on the three-dimensional image portion 404 at the bottom of the image 402 displayed on the display device 106, the interface image portion 406 may be located elsewhere on the image 402, such as the top, left, middle, or right sides. In another embodiment, the interface portion 406 may not be overlaid on the three-dimensional image portion 203, such that the interface image portion 406 is displayed as a separate image. It is also possible that the interface image portion 406 and the three-dimensional image portion 404 are displayed on more than one display device.

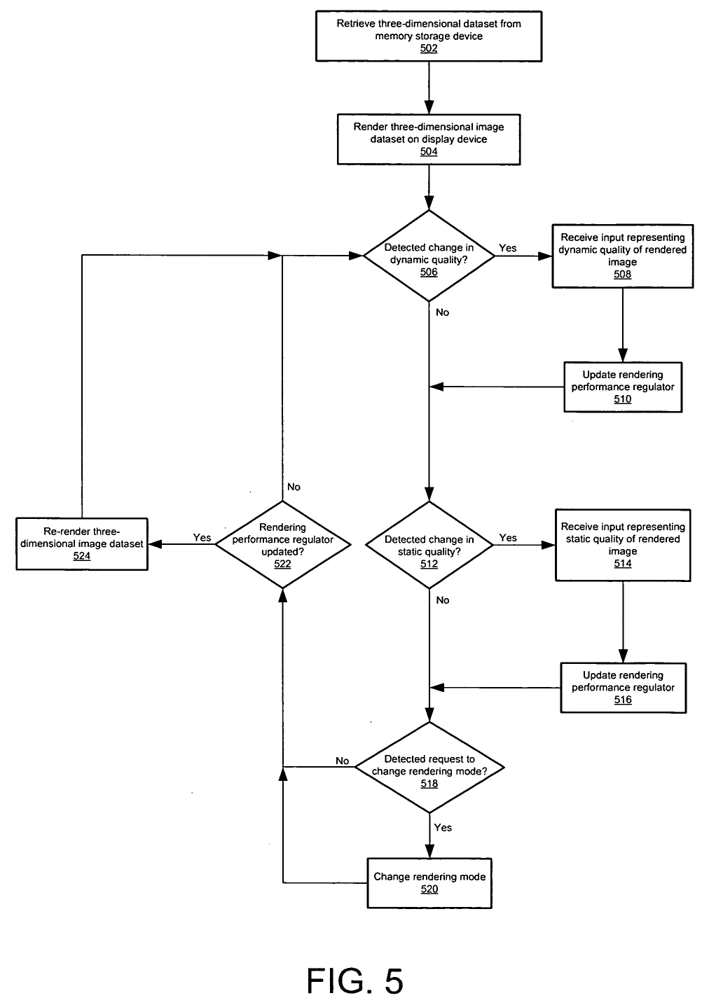

FIG. 5 is a flow chart diagram of one embodiment of a method for regulating the rendering of three-dimensional images displayed on a display device. The flow chart diagram shown in FIG. 5 may be implemented by the system of FIG. 1, and reference to FIG. 1 is made in the following description of FIG. 5. Other systems may be used. Initially, the processor 114, the graphics processing unit 116, or combinations thereof, retrieves the three-dimensional dataset from the memory storage device 118 (Block 502). As previously described, the user of the system 102 may have previously input the three-dimensional image dataset into the memory storage device 118 using the input device 104. Alternatively, the system 102 may have acquired the three-dimensional image dataset using one of the aforementioned imaging techniques previously described and stored the three-dimensional image dataset in the memory storage device 118. Real-time input with scanning may be used.

After retrieving the three-dimensional dataset from the member storage device 118, the processor 114, graphics processing unit 116, or combinations thereof then renders the three-dimensional image dataset on the display device 106 (Block 504). In one embodiment, the processor 114 bypasses the graphics processing unit 116 to render the three-dimensional image dataset on the display device 106. In another embodiment, the processor 114 instructs the graphics processing unit 116 to render three-dimensional image dataset on the display device 106.

The quality of the rendered three-dimensional image may be a default-quality image, a low-quality image, or a high-quality image. The quality of the rendered three-dimensional image may further be selected by the user using the input device 104 prior to rendering the three-dimensional image dataset on the display device 106. The quality of the rendered three-dimensional image may also be selected by the rendering performance regulator 112 prior to rendering the three-dimensional image dataset on the display device 106. At the time the three-dimensional image dataset is rendered on the display device 106, the interface for interacting with the rendering performance regulator 112 is also displayed. As previously described, the interface for interacting with the rendering performance regulator 112 may be displayed on the same image as the rendered three-dimensional image, or in a separate image from the rendered three-dimensional image. The interface and the rendered three-dimensional image may further be displayed on one or more display devices.

After rendering the three-dimensional image dataset on the display device 106 (Block 504) and displaying the interface for interacting with the rendering performance regulator 112, the processor 114 waits for an input from the input device 104. The input from the input device 104 may be to change the quality of the dynamic rendering of the three-dimensional image dataset, to change the quality of the static rendering of the three-dimensional image dataset, to change the type of rendering, such as from dynamic to static or from static to dynamic, of the rendered three-dimensional image dataset, or combinations thereof. The input from the input device 104 may also be an input to interact with the rendered three-dimensional image. Where no input is received from the input device 104, the processor 114, the graphics processing unit 116, or combinations thereof, continues to display the rendered image of the three-dimensional image dataset on the display device 106.

Where the input device 104 is used to manipulate the interface of the rendering performance regulator 112, the input device 104 sends an input signal to the rendering performance regulator 112. The input signal may be sent directly to the rendering performance regulator 112 or indirectly, such as through processor 114, graphics processing unit 116, or combinations thereof. If there is a detected change in the quality of the dynamic rendering of the three-dimensional image (Block 506), the rendering performance regulator 112 receives the input representing the change in the quality of the dynamic rendering (Block 508). The rendering performance regulator 112 is then updated to reflect the change in the dynamic rendering (Block 510). Similarly, if there is a detected change in the quality of the static rendering of the three-dimensional image (Block 512), the rendering performance regulator 112 receives the input representing the change in the quality of the static rendering (Block 514). The rendering performance regulator 112 is then updated to reflect the change in the static rendering (Block 516).

The change in the quality of the static or dynamic rendering of the three-dimensional image dataset may be a relative detected change or a value representing the updated quality of the rendered three-dimensional image. In one embodiment, updating the rendering performance regulator 112 means taking the difference between an original quality value and an updated quality value. Where the updated quality value exceeds the original quality value, the rendering performance regulator 112 takes the absolute value of the difference between the original quality value and the updated quality value, and adds the absolute value of the difference to the original quality value. In another embodiment, updating the rendering performance regulator 112 means replacing an original quality value with an updated quality value.

The input to the rendering performance regulator 112 may also be a request to change the rendering mode of the processor 114, graphics processing unit 116, or combinations thereof. For example, the input may request to change a static rendering of the three-dimensional image dataset to a dynamic rendering of the three-dimensional image dataset. Where the rendering performance regulator 112 detects an input that changes the rendering mode (Block 518), the rendering performance regulator 112 is updated to reflect that a request has been made to change the rendering mode (Block 520).

In one embodiment, while the rendered three-dimensional image is displayed on the display device 106, the processor 114 periodically polls the rendering performance regulator 112 to determine whether input from the input device 104 has updated the rendering performance regulator 112 (Block 522). In an alternative embodiment, the rendering performance regulator 112 polls itself to determine whether it has been updated (Block 522). Where the rendering performance regulator 112 has been updated, the processor 114, graphics processing unit 116, or combinations thereof, re-renders the three-dimensional image dataset based on the updates made to the rendering performance regulator 112 (Block 524). For example, where the rendering performance regulator 112 has been updated based on a detected change in the quality level of the dynamic rendering of the three-dimensional image dataset, the processor 114, graphics processing unit 116, or combinations thereof, re-renders the three-dimensional image dataset based on the updated detected change.

Alternatively, the re-rendering of the three-dimensional image dataset (Block 524) may occur upon a request by the user using the input device 104. For example, suppose that the user increases the quality level of the dynamic rendering of the three-dimensional image dataset, but wishes to continue viewing a static rendering of the three-dimensional image dataset. In this example, the display device 106 will continue displaying the static rendering of the three-dimensional image dataset until the user inputs a request to change the rendering mode from static to dynamic. After the user inputs a request to change the rendering mode from static to dynamic, the display device 106 then displays a dynamic rendering of the three-dimensional image dataset based on the updates in the quality level previously made by the user while the static rendering of the three-dimensional image dataset was displayed. In this manner, a user may adjust the quality level of a non-displayed rendering without affecting the display of a displayed rendering.

The quality of the rendered three-dimensional image or the rendering mode used to render the three-dimensional image may be selected by the user while the processor 114, graphics processing unit 116, or combinations thereof, is rendering the three-dimensional image. For example, while the processor 114, graphics processing unit 116, or combinations thereof, is rendering a low-quality three-dimensional image, the user may provide an input that increases the quality of the three-dimensional image. In this example, the processor 114, graphics processing unit 116, or combinations thereof, ceases rendering of the low-quality three-dimensional image and proceeds to render the three-dimensional image at the quality selected by the user. As another example, while the processor 114, graphics processing unit 116, or combinations thereof, is rendering a dynamic three-dimensional image, the user may provide an input that changes the rendering mode of the processor 114, graphics processing unit 116, or combinations thereof, to render a static three-dimensional image. In this example, the processor 114, graphics processing unit 116, or combinations thereof, ceases the rendering of the dynamic three-dimensional image and process to render a static three-dimensional image. In this situation, where the user provides an input that interrupts the current rendering process, the system 102 may prompt the user as to whether the user wants to interrupt the current rendering process or whether the user wants to wait until the current rendering process is completed.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A system for regulating the rendering of three-dimensional images displayed on a display device, the system comprising:
a memory storage device operative to store a three-dimensional image dataset;
a processor operative to receive the three-dimensional image dataset from the memory storage device and operative to render the three-dimensional image dataset as the three-dimensional image; and
a display device operative to display the three-dimensional image rendered by the processor and to display an interface operative to regulate the performance of the processor in rendering the three-dimensional image, the interface including:
a progress indicator that indicates the rendering quality of the three-dimensional image;
a process bar that indicates the progress of the rendering of the three-dimensional dataset performed by the processor; and,
a first input handler operative to receive an input that selects the rendering quality of the three-dimensional image.

2. The system of claim 1, wherein the display device is operable to display the three-dimensional image and the interface as a single image.

3. The system claim 1, wherein the processor is further operative to render the three-dimensional image as a static or a dynamic three-dimensional image.

4. The system of claim 1, wherein the progress indicator of the interface comprises a dynamic rendering progress indicator and a static rendering progress indicator.

5. The system of claim 1, wherein the process bar is further operative to indicate a dynamic or static rendering process performed by the processor.

6. The system of claim 1, wherein the interface further includes a second input handler operative to receive an input that selects the rendering quality of the three-dimensional image.

7. The system of claim 6, wherein the first input handler is operative to receive an input that selects a dynamic rendering quality of the three-dimensional image and the second input handler is operative to receive an input that selects a static rendering quality of the three-dimensional image.

8. A method for regulating the rendering of three-dimensional images displayed on a display device, the method comprising:
rendering a three-dimensional image dataset as the three-dimensional image; and,
displaying the rendered three-dimensional image and an interface, the interface including:
a progress indicator that indicates the rendering quality of the three-dimensional image;
a process bar that indicates the progress of the rendering of the three-dimensional dataset; and,
a first input handler operative to receive an input that selects the rendering quality of the three-dimensional image.

9. The method of claim 8, wherein displaying the three-dimensional image and the interface comprises displaying the three-dimensional image and the interface as a single image.

10. The method of claim 8, wherein rendering the three-dimensional image dataset as the three-dimensional image comprises rendering the three-dimensional image as a static or dynamic three-dimensional image.

11. The method of claim 8, wherein the progress indicator of the interface comprises a dynamic rendering progress indicator and a static rendering progress indicator.

12. The method of claim 8, wherein the process bar is further operative to indicate a dynamic or static rendering process of the three-dimensional image.

13. The method of claim 8, wherein the interface further includes a second input handler operative to receive an input that selects the rendering quality of the three-dimensional image.

14. The method of claim 13, wherein the first input handler is operative to receive an input that selects a dynamic rendering quality of the three-dimensional image and the second input handler is operative to receive an input that selects a static rendering quality of the three-dimensional image.

15. A computer-readable medium having computer-executable instructions for performing a method, the method comprising:
rendering a three-dimensional image dataset as the three-dimensional image; and,
displaying the rendered three-dimensional image and an interface, the interface including:
a progress indicator that indicates the rendering quality of the three-dimensional image;
a process bar that indicates the progress of the rendering of the three-dimensional dataset; and
a first input handler operative to receive an input that selects the rendering quality of the three-dimensional image; and
regulating the rendering of the three-dimensional image as a function of input associated with the first input handler.

16. The computer-readable medium of claim 15, wherein displaying the three-dimensional image and the interface comprises displaying the three-dimensional image and the interface as a single image.

17. The computer-readable medium of claim 15, wherein rendering the three-dimensional image dataset as the three-dimensional image comprises rendering the three-dimensional image as a static or a dynamic three-dimensional image.

18. The computer-readable medium of claim 15, wherein the progress indicator of the interface comprises a dynamic rendering progress indicator and a static rendering progress indicator.

19. The computer-readable medium of claim 15, wherein the process bar is further operative to indicate a dynamic or static rendering process of the three-dimensional image.

20. The computer-readable medium of claim 15, wherein the interface further includes a second input handler operative to receive an input that selects the rendering quality of the three-dimensional image.

21. The computer-readable medium of claim 20, wherein the first input handler is operative to receive an input that selects a dynamic rendering quality of the three-dimensional image and the second input handler is operative to receive an input that selects a static rendering quality of the three-dimensional image.

22. The computer-readable medium of claim 15, wherein the method further comprises regulating the rendering of the three-dimensional image as a function of input associated with the second input handler
